(19) United States
(12) Patent Application Publication
(10) Pub. No.: US 2025/0061139 A1
(43) Pub. Date: Feb. 20, 2025

(54) SYSTEMS AND METHODS FOR SEMANTIC SEARCH SCOPING

(71) Applicant: CS Disco, Inc., Austin, TX (US)

(72) Inventors: Liad Levinson, Austin, TX (US); Matthew Jefferson Hinze, Austin, TX (US); Adam Peterson, Austin, TX (US)

(21) Appl. No.: 18/809,064

(22) Filed: Aug. 19, 2024

Related U.S. Application Data
(60) Provisional application No. 63/520,275, filed on Aug. 17, 2023.

(51) Int. Cl. G06F 16/33; G06F 16/332

(52) U.S. Cl. CPC G06F 16/3344; G06F 16/3326; G06F 16/3349

(57) ABSTRACT

A computer-implemented method for searching electronic documents is provided. The method executing a non-semantic search, such as lexical search, to identify documents from a document corpus that meet the search criteria of the non-semantic search. A subsequent semantic search can be scoped based on the results of the non-semantic search. The method can thus include executing a semantic search scoped to the documents identified in the non-semantic search result to generate a semantic search result that identifies content that is semantically relevant to a natural language query. Thus, the semantically relevant content can have both non-semantic (e.g., lexical) and semantic relevance.

### RELATED APPLICATIONS

This application claims the benefit of priority under 35 U.S.C. § 119 (e) of U.S. Provisional Patent Application 63/520,275, entitled “Systems and Methods for Semantic Search Scoping,” filed Aug. 17, 2023, which is hereby fully incorporated by reference herein.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records but reserves all other copyright rights whatsoever.

### TECHNICAL FIELD

This disclosure relates generally to searching electronic documents. Even more particularly, embodiments of the present application relate to enhancing searching of large bodies of potentially complex documents by scoping semantic searches using non-semantic searches.

### BACKGROUND

In the modern world, many documents that are being created, utilized, and maintained are in electronic format. Several situations commonly arise that require an analysis or identification of certain relevant electronic documents from a relatively large pool of available electronic documents. These situations are generally referred to as information retrieval or search problems. These types of search problems crop up in a wide variety of contexts. For example, in litigation, an attorneys may have to search through a large volume of documents provided by their client and received during discovery to find information needed to

To illustrate in more detail, parties to litigation typically must share relevant evidence with opposing counsel through the discovery process. In many cases, each party makes a reasonable search of their records based on some set of terms or keywords and produces the results of the search to the other party. Discovery thus typically involves the gathering of potentially relevant materials, much of it digital, and then reviewing such materials to determine what to be shared with opposite parties. Additionally, during the litigation, the lawyers must continually review those documents produced both by their own client and by the opposing party to locate documents relevant to the case at hand. Litigation thus represents a microcosm of a more general problem raised by the high volume of electronic documents present in a variety of contexts. Namely, how a large volume of electronic documents can be understood, reviewed, or searched in order that documents relevant to a particular topic or user's interest may be located.

Document analysis systems help resolve these problems. A document analysis system is a computer-implemented system that allows users to search, analyze, review, or navigate information in a corpus to locate electronically stored information of interest. Document analysis systems are often tailored to specific contexts, such as electronic discovery, academic research, etc. E-discovery systems, for example, include tools to allow attorneys to search documents for review, exhaustively tag the documents, and use the tags to determine whether and how to produce documents, thus assisting in review for production. An attorney may also use a document analysis system during investigation, where the attorney determines the facts of a case and finds evidence for or against those facts.

Document analysis systems typically support lexical searching of documents. In a common scenario, a user of a document analysis system submits a query to the document analysis system to search a corpus of documents and the search engine of the document analysis system selects a set of results from the corpus based on the terms of the search query. The terms of search queries usually specify words, terms, phrases, logical relationships, metadata fields to be searched, synonyms, stemming variations, etc. The search engine performs a lexical search on metadata fields and, in some systems, document content for literal matches of words, terms, phrases or variants to identify documents and returns the documents that meet the logical constraints specified in the search.

With lexical search, the meaning or intent of the query can be lost. This can result in the search engine missing documents that meet the intent behind the query but do not match the words in the query. On the other hand, a lexical search may also return many documents that match the search terms but are not relevant to the intent behind the query.

Some document management systems also support other types of searches, such as semantic search, which attempts to understand the intent and contextual meaning behind a search query to provide more relevant results. Semantic searching is more time-consuming and computationally expensive than lexical searching and can produce less accurate results than lexical searching when the semantic search query does not contain enough context.

In document analysis systems that support multiple types of searches, each search type (e.g., lexical, semantic, etc.) is treated as a different problem domain and considered independently. If, for example, a user wishes to run a lexical search and a semantic search, they use a lexical search tool for the lexical search and a semantic search tool for the semantic search. If a user is interested in documents that match different types of searches, the user must compare the search results from the different types of searches. For example, if the user is interested in documents that both have specific lexical characteristics and semantic meaning, it is left to the user to determine which documents are of interest by reviewing both lexical search results and the independent semantic search results. Document analysis tools do not provide a way to seamlessly change between search types.

What is desired, therefore, are improved systems and methods for searching large bodies of potentially complex documents.

### SUMMARY

Embodiments of the present disclosure provide systems and methods for scoping semantic searches to enhance the accuracy of semantic searches and, in some embodiments, generative artificial intelligence.

According to one aspect of the present disclosure, a computer-implemented method for searching electronic documents is provided. The method may include receiving a non-semantic search query from a user to search a document corpus and executing a non-semantic search according to the non-semantic search query to generate a first search result that identifies first documents from the document corpus. The non-semantic search, according to one embodiment, is a lexical search. The method may further include receiving a natural language query from the user and servicing the natural language query to generate a response to the user. Servicing the natural language query may include executing a semantic search scoped to the first documents—that is the documents identified in the results of the non-semantic search—to generate a semantic search result that identifies semantically relevant content that is semantically relevant to the natural language query. According to one embodiment, the natural language query is a query to an AI-search assistant.

Some embodiments include providing the first search result to the user in a graphical user interface and receiving, via user interaction with the graphical user interface, an indication to scope the semantic search to the first documents. According to another embodiment, the semantic search is automatically scoped to the first documents.

According to one embodiment, servicing the natural language query comprises generating an input to a large language model where the input comprises the natural language query and the semantically relevant content to cause the large language model to generate text to respond to the natural language query based on the semantically relevant content. One embodiment further comprises receiving generative text generated by the large language model in response to the input and providing the generative text to the user in response to the natural language query. The input to the large language model, according to one embodiment, includes the natural language query as a prompt and the semantically relevant content as a context for responding to the prompt.

In some embodiments, the semantically relevant content comprises text chunks associated with the documents identified in the non-semantic search results. In another example embodiment, the semantically related content comprises semantically related documents from the documents identified in the non-semantic search result.

According to another aspect of the present disclosure, a non-transitory, computer-readable medium for searching electronic documents is provided. The non-transitory, computer-readable medium embodies code that includes instructions executable for receiving a non-semantic search query from a user to search a document corpus and executing a non-semantic search according to the non-semantic search query to generate a first search result that identifies first documents from the document corpus. The non-semantic search, according to one embodiment, is a lexical search. The code may further include instructions executable for receiving a natural language query from the user and servicing the natural language query to generate a response to the user. Servicing the natural language query may include executing a semantic search scoped to the first documents—that is the documents identified in the results of the non-semantic search—to generate a semantic search result that identifies semantically relevant content that is semantically relevant to the natural language query. According to one embodiment, the natural language query is a query to an AI-search assistant.

Some embodiments include instructions executable for providing the first search result to the user in a graphical user interface and receiving, via user interaction with the graphical user interface, an indication to scope the semantic search to the first documents. According to another embodiment, the semantic search is automatically scoped to the first documents.

According to one embodiment, servicing the natural language query comprises generating an input to a large language model where the input comprises the natural language query and the semantically relevant content to cause the large language model to generate text to respond to the natural language query based on the semantically relevant content. One embodiment further comprises executable instructions for receiving generative text generated by the large language model in response to the input and providing the generative text to the user in response to the natural language query. The input to the large language model, according to one embodiment, includes the natural language query as a prompt and the semantically relevant content as a context for responding to the prompt. In some embodiments, the semantically relevant content comprises text chunks associated with the documents identified in the non-semantic search results. In another example embodiment, the semantically related content comprises semantically related documents from the documents identified in the non-semantic search result.

Another aspect of the present disclosure provides a computer system providing enhanced search. The computer system may include storage, processor, and memory. The storage may include a plurality of snippets. Each of the plurality of snippets may comprise snippet text extracted from a document in a document corpus and a reference to the document from which the snippet text of that snippet was extracted. The storage may further store an embedding store comprising a vector index of the plurality of snippets.

The memory stores a non-semantic search engine and a semantic search engine. The non-semantic search engine may be executable to search the document corpus. According to one embodiment, the non-semantic search engine is a lexical search engine. The semantic search engine may be executable to perform semantic searching of the document corpus using the vector index. The memory may further comprise instructions executable to scope semantic searches by the semantic search engine to documents identified in search results from the non-semantic search engine.

According to one embodiment, the memory further stores instructions executable to receive a non-semantic search result from the non-semantic search engine where the non-semantic search results comprise document identifiers for first documents from the document corpus. The memory may further store instructions executable to store the document identifiers from the non-semantic search results as query parameters for a subsequent search. The memory may further store instructions executable to receive a natural language query after the non-semantic search result. The natural language query includes a query string from a user. The memory may further store instructions executable to generate a request to the semantic search engine that includes the query string and the document identifiers that were stored as query parameters.

In some embodiments, the semantic search engine is executable to receive the query string and the document identifiers execute a corresponding semantic search scoped to the first documents to generate a semantic search result that identifies semantically relevant content that is semantically relevant to the query string.

According to one embodiment, the memory further stores instructions executable to generate an input to a large language model, the input to the large language model comprising the query string and the semantically relevant content from the semantic search result, receive generative text generated by the large language model to respond to the input string based on the semantically relevant content and display the generative text to the user.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a document analysis system.

FIG. 2 is a diagrammatic representation of one embodiment of a request and response flow.

FIG. 3 is a diagrammatic representation of another embodiment of a document analysis system.

FIG. 4A is a diagrammatic representation of one embodiment of a request and response flow in the document analysis system of FIG. 3.

FIG. 4B is a diagrammatic representation of another embodiment of a request and response flow in the document analysis system of FIG. 3.

FIG. 4C is a diagrammatic representation of another embodiment of a request and response flow in the document analysis system of FIG. 3.

FIG. 4D is a diagrammatic representation of another embodiment of a request and response flow in the document analysis system of FIG. 3.

FIG. 5A, FIG. 5B, FIG. 5C, FIG. 5D, FIG. 5E, and FIG. 5F depict portions of one embodiment of a user interface.

FIG. 6 is a diagrammatic representation of one embodiment of a network environment.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and specific examples, while indicating the preferred embodiments, are given by way of illustration only and not by way of limitation. Descriptions of known programming techniques, computer software, hardware, operating platforms, and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

Embodiments of the present disclosure provide systems and methods for enhancing semantic search and, in some embodiments, artificial intelligence (AI)-based text generation by scoping servicing of natural language queries based on the results of non-semantic searches. More particularly, embodiments may, for example, scope semantic searches based on the results of lexical searches.

According to one embodiment, a document analysis system can provide an interface that allows a user to run multiple types of searches (e.g., non-semantic search, semantic search, or other types of searches) or a system to implement a workflow that runs multiple types of searches. The search results from a search are used to scope a next search (or other subsequent search), either automatically or based on user selection. For example, the search results of a non-semantic search can be used to scope a semantic search to documents returned by the non-semantic search. Embodiments of the present disclosure allow a user or system to switch between search types while maintaining context from a prior search, even if the prior search was of a different type. Embodiments can increase the relevancy of a search by limiting the search to a narrower context provided by the results of a prior search, potentially of a different search type.

Generative AI is becoming an increasingly important tool for analyzing documents. Embodiments of the present disclosure can be employed to scope the content used by generative AI when responding to a query to focus the generative AI on documents that have specific lexical or semantic characteristics, thus increasing the accuracy of the responses produced by the generative AI.

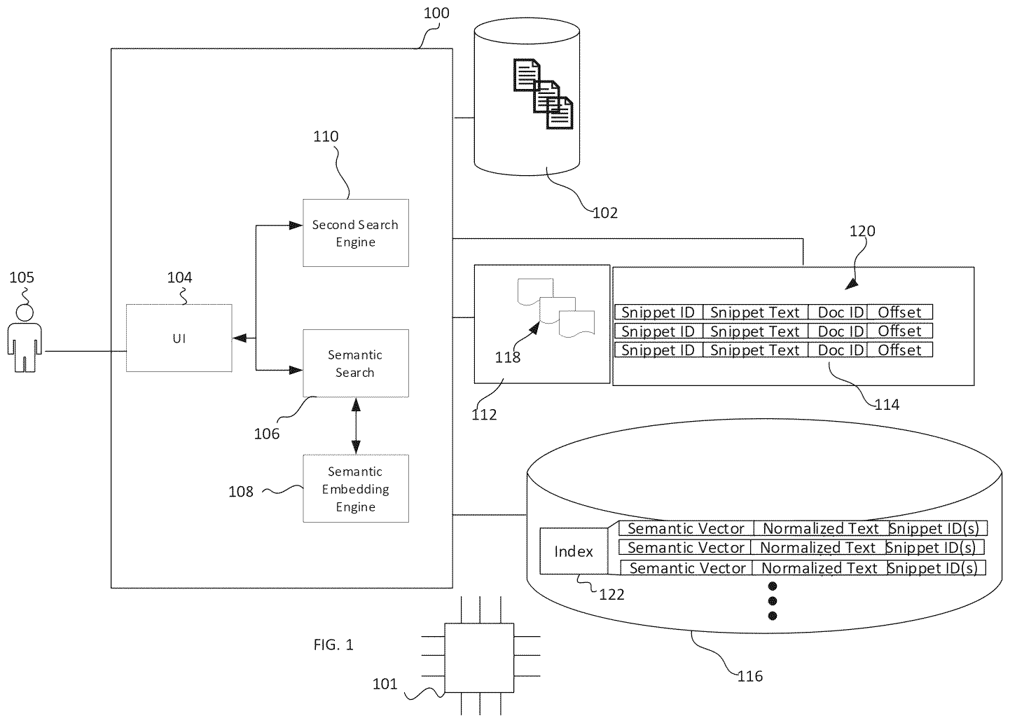

FIG. 1 is a diagrammatic representation of one embodiment of a document analysis system 100. Document analysis system 100 executes on a processor 101, which, in some embodiments, comprises a plurality of processors of a plurality of computers that execute code to provide a document analysis system. The code is embodied, in some embodiments, on a non-transitory, computer readable medium.

Document analysis system 100 supports various types of search technologies for searching a large corpus of documents (document corpus 102). In some embodiments, document corpus 102 includes documents stored on a variety of storage technologies, including across heterogeneous storage technologies (e.g., stored on remote or local databases, remote or local file systems, cloud stores or other storage technologies). Documents in document corpus 102 are assigned unique document identifiers (document IDs) in document analysis system 100.

In the embodiment illustrated, document analysis system 100 includes a user interface 104 through which a user 105 can interact with the system, a semantic search engine 106, a semantic embedding engine 108, and a second search engine 110. According to one embodiment, second search engine 110 performs a different type of search from semantic search engine 106. For example, in one embodiment, second search engine 110 is a lexical search engine that performs a lexical search of documents in corpus 102.

User interface 104 allows user 105 to submit search queries according to the supported search types. Document analysis system 100 can service new queries in the context of prior searches. For example, document analysis system 100 may constrain a lexical search to the results of the semantic search. Thus, iterative searches may be performed in the context of prior searches.

Document analysis system 100 includes a text store 112, a snippet store 114, and an embedding store 116 for storing data related to searching document corpus 102. Each of text store 112, snippet store 114, and embedding store 116 comprises a file system, a database, or other storage technologies or combinations thereof. While illustrated separately, two or more of text store 112, snippet store 114, or embedding store 116 may represent portions of the same data store.

The text of searchable documents from document corpus 102 is stored in document analysis system 100 as index text 118 for the documents. According to one embodiment, the index text 118 for a document comprises a character array of characters from the document—for example, as a single dimensional character array in one embodiment.

To support semantic search, the documents from document corpus 102 may be semantically embedded as document text vectors that represent the document text for semantic searching. More particularly, the documents from document corpus 102 may be broken down into more manageable chunks of text, referred to herein as original text chunks, and the original text chunks semantically embedded as document text vectors. As discussed below, the process of semantically embedding an original text chunk may involve normalizing the original text chunk and semantically embedding the normalized text chunk as the document text vector representing the text chunk.

According to one embodiment, each of the original text chunks associated with a document is a sequence of characters within the index text 118 of a document. In an even more particular embodiment, an original text chunk is a single dimension aware sequence of characters within the index text 118 of a document. According to one embodiment, an original text chunk has a start offset and end offset within the character array of the index text 118 of a document. In some embodiments, the original text chunks follow a set of delineation rules, such as, but not limited to junk text is excluded, punctuation is preserved, capitalization is preserved. The amount of text in an original text chunk will depend on the chunking rules applied. According to one embodiment, the documents from document corpus 102 are chunked into defined grammatical units, such as sentences.

The original text chunks are stored as snippets 120 in snippet store 114. According to one embodiment, a snippet 120 comprises an original text chunk (snippet text), a document ID of a document from document corpus 102, and an offset in a document coordinate system indicating the location of the snippet text in the document (that is, the location of the snippet text in the document having the document ID with which the snippet is associated). A snippet may thus be an original text chunk in the context of a document. Each snippet 120 can be assigned a unique id according to one embodiment.

The snippet texts—that is, the original text chunks—are semantically embedded as document text vectors. Various text embedding models known or developed in the art can be used to semantically embed a text chunk as a document text vector for semantic search. According to one embodiment, a multi-qa-mpnet-base-dot-v1 model is used to generate the text embeddings.

As will be appreciated, semantic embedding may involve text normalization, such as, but not limited to removing white space, removing email line breaks, etc. Thus, according to one embodiment, the embedding process may normalize the original text chunks from snippets 120 as normalized text chunks for embedding as the document text vectors. In some cases, multiple original text chunks from the same document or across documents normalize to the same normalized text chunk (e.g., the same normalized sentence) and thus the same semantic embedding (the same document text vector).

Embedding store 116 comprises a vector index 122 of snippets that associates the semantically embedded text chunks—that is, the document text vectors—with snippets. In a more particular embodiment, index 122 maps the document text vectors to normalized text chunks from which the document text vectors were generated and the snippets 120 from snippet store 114 that map to the normalized text chunks. Because the snippet text in multiple snippets may map to the same normalized text and hence semantic vector, multiple snippets 120 may map to the same normalized text chunk and document text vector in index 122.

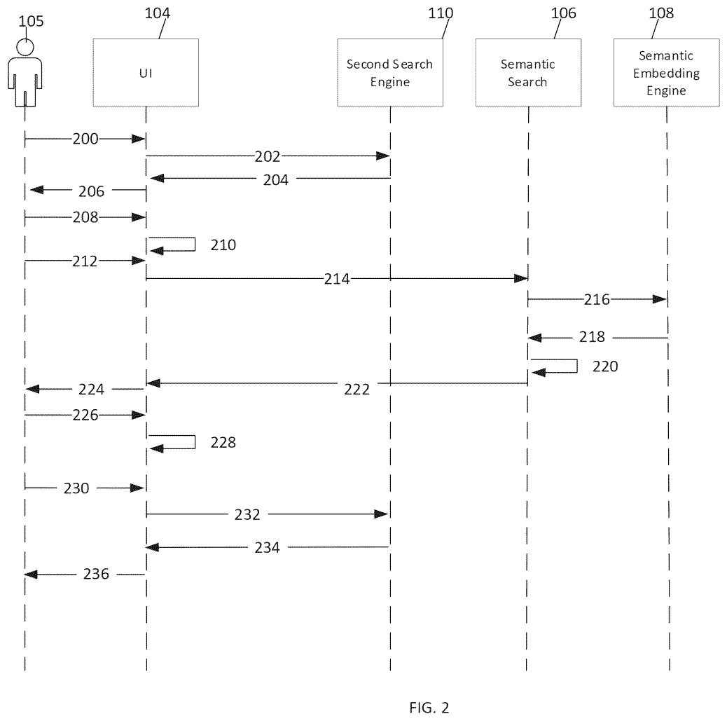

In some embodiments, one or more of the components of document analysis system 100 may be provided by a different system or a third party. Further, document analysis system 100 may include additional or alternative services. For example, document analysis system 100 may include various services to orchestrate searches and reviews of results. Thus, for example, a request illustrated as flowing from one component to another in FIG. 2 may be processed and conditioned by one or more intermediate services between the components.

Turning to FIG. 2, one embodiment of a flow in document analysis system 100 is illustrated. UI 104 receives a non-semantic search query 200 for second search engine 110. In an embodiment in which second search engine 110 is a lexical search engine, query 200 includes lexical search criteria, such as words, phrases, logical operators, or other search criteria supported by the lexical search engine. User interface 104 sends a search request 202 to search engine 110 with the search criteria. Search engine 110 executes the search and returns search results 204 (e.g., a lexical search result) that includes a list of hits. According to one embodiment, each hit is a reference to a document from corpus 102 that meets the search criteria. For each hit, search results 204 may include, for example, the document ID of the document. In some embodiments, search results 204 include, for each document referenced, one or more of the document name, representative content from the document, or metadata associated with the document. UI 104 displays search results 204 to the user (output 206). UI 304 tracks one or more prior search results as potential scopes for servicing subsequent queries.

User 105 may wish to run a further search, such as a semantic search. In one embodiment, UI 104 provides the user the option to scope the next search to the documents returned from a previous search, such as search results 204. Thus, the user may select to scope the next search to the documents returned in search results 204 (or other prior search result). Based on user interaction with UI 104, UI 104 can thus receive input 208 indicating that the next search is to be scoped to documents returned from the previous search. In some embodiments, user 305 may select a subset of documents from search result 406 to which a subsequent search should be scoped. UI 104, at parameter update 210, updates query parameters with constraints to limit servicing of the next query to the documents identified in a previous search result (e.g., search results 204). For example, UI 104 may store the document IDs of the documents identified in search results 406 or selected subset of documents as query parameters.

In another embodiment, document analysis system 100 is configured to automatically update the query parameters so that the next search in a defined logical flow, such as a search session, conversation, or a dialog, is to be done in the scope of the previously returned documents without explicit user selection or in the absence of user opt-out. In other words, parameter update 210 may occur automatically without user input.

As discussed, user interface 104, according to some embodiments, supports multiple search technologies. For example, user interface 104 may also allow user 105 to submit a semantic search query to search corpus 102. Thus, user interface 104 can receive a semantic search query 212 (e.g., a natural language search query) that includes an input string for semantic search. UI sends a search request 214 to semantic search engine 106. If the search is to be scoped to documents returned in the previous search, the semantic search request 214 also includes query parameters that constrain the search scope based on prior search results. For example, semantic search request 214 may include the document IDs from prior search results 204 (e.g., as stored at parameter update 210).

Semantic search engine 106 sends a request 216 to semantic embedding engine 108 to embed the user input string. Semantic embedding engine 108 semantically embeds the input string as a semantic vector (a query vector). According to one embodiment, semantic embedding engine 108 embeds the input string in the same way the original text chunks were embedded, including normalizing the input string for embedding in the same manner as the original chunks were normalized for embedding. Semantic embedding engine 108 returns a response 218 to semantic search engine 106 that includes the query vector (that is, the semantically embedded (normalized) input string).

Semantic search engine 106 performs a semantic search of index 122 using the query vector to identify semantically relevant content that is responsive to semantic search request 214 and generates semantic search results 222 based on the responsive semantically relevant content or references to the responsive semantically relevant content. According to one embodiment, semantic search engine 106 supports the approximate matching of text chunks that enables the semantics to be found with related meaning.

Various methods of identifying semantically relevant content may be employed. According to one embodiment, semantic search engine determines the similarity between the query vector (e.g., the semantically embedded input string) and a document text vector (a semantically embedded text chunk) and by computing a similarity score—for example, a cosine similarity—between the embeddings. Semantic search engine 106 can thus determine that a document text vector is a semantically relevant document text vector based on the similarity score determined for the document text vector.

In one embodiment, semantic search engine 106 identifies the normalized text chunks and snippets mapped to the semantically relevant document vectors in index 122 as semantically relevant to search query 200. Further, in some embodiments, semantic search engine 106 identifies the documents identified in semantically relevant snippets as documents that are semantically relevant to search query 200.

If semantic search request 214 includes search constraints, semantic search engine 106 applies a search scope filter 220 to filter the identified semantically relevant content to only include, as responsive semantically relevant content, the scoped semantically relevant content that is within the search scope specified by the search constraints. In one embodiment, for example, semantic search engine 106 may identify as scoped semantically relevant snippets the semantically relevant snippets that contain a document ID that matches a document ID provided as a constraint in search request 214. Further, semantic search engine 106 may identify as scoped semantically relevant normalized text chunks the semantically relevant normalized text chunks that are mapped to responsive semantically relevant snippets in index 122. Similarly, semantic search engine 106 may identify as scoped semantically relevant documents the semantically relevant documents that have a document ID that matches a document ID provided as a constraint in search request 214.

In another embodiment, semantic search engine 106 is configured to limit the search of documents to documents identified in search request 214. For example, semantic search engine 106 may filter entries in index 122 to only those entries corresponding to documents identified as a constraint in search request 214 and then perform a search to identify semantically relevant content. Thus, the semantically relevant content determined in this manner can be considered scoped semantically relevant content.

According to one embodiment, semantic search results 222 includes citations for responsive semantically relevant snippets. In an even more particular embodiment, semantic search results 222 includes citations for semantically relevant snippets scoped to documents identified in search request 214. According to one embodiment, the citation for a snippet includes snippet information for the snippet, the snippet information for a snippet includes a text chunk (e.g., one or more of the normalized text chunk mapped to the snippet or the original text chunk from the snippet) and a reference to one or more of the snippet (e.g., the snippet ID) or the document identified in the snippet (e.g., the document ID from snippet). Other examples of information that may be included in the snippet information of a citation include but are not limited to the snippet offset, document metadata (e.g., Author or other metadata), of the document identified by the snippet, a citation for a relevance score for the normalized text chunk mapped to the snippet, or relevance score for the original text chunk from the snippet. In some embodiments, citations include entire snippets. A citation for a semantically relevant snippet may include, in some embodiments, snippet information for snippets before or after a semantically relevant snippet.

User interface 104 displays the results (e.g., the citations to the user) (output 224). The user may be given the option to perform another semantic search or another type of search (e.g., a lexical search). According to one embodiment, the user is given an option to search within the scope of prior search results, such as search results 222. Based on user interaction with UI 104, UI 104 can thus receive an input 226 indicating that the next search is to be scoped to documents returned from a previous search—for example, the documents identified in the citations of semantic search results 222 or identified in the snippets referenced by the citations of semantic search result 222. In some embodiments, user 105 may select a subset of the documents. UI 104, at parameter update 228, updates query parameters with constraints to limit servicing of the next query to the documents based on the previous search result (e.g., search results 222). For example, UI 104 may store the document IDs of the documents identified in the citations of semantic search results 222 or identified in the snippets referenced by the citations of semantic search result 222, or selected subset thereof.

In another embodiment, document analysis system 100 is configured to automatically update the query parameters so that the next search in a defined logical flow, such as a search session, conversation, or a dialog, is to be done in the scope of the previously returned documents without explicit user selection or in the absence of user opt-out. In other words, parameter update 228 may occur automatically without user input.

The user enters another search query 230, for example, a search query for second search engine 110. In an embodiment in which second search engine 110 is a lexical search engine, query 230 includes lexical search criteria, such as words, phrases, logical operators, or other search criteria supported by the lexical search engine. UI 104 formulates a request 232 to second search engine 110 that includes the user's query parameters with constraints to limit the search to the documents identified from semantic search results 222 (e.g., the document IDs included query parameter update 228).

Search engine 110 executes the search and returns search results 234 (e.g., a lexical search result) that includes a list of hits. The results are displayed to user 105 (output 236). According to one embodiment, each hit is a reference to a document from corpus 102 that meets the search criteria of search request 232. For each hit, search results 234 may include, for example, the document ID of the document. In some embodiments, search results 234 include, for each document referenced, one or more of the document name, representative content from the document, or metadata associated with the document. The hits, however, are limited to the documents having document IDs included in the constraints of search request 232.

Thus, user 105 may perform multiple searches in the context of a defined logical flow, such as a search session, conversation, or a dialog. According to one embodiment, if user 105 performs a first search and then, in the context of the defined logical flow, submits another search query, document analysis system 100 performs the new search within the scope of the documents returned by the prior search, even if the prior search was a different type of search. Thus UI 104 (or another component of document analysis system 100) can scope a new search to the documents referenced in prior search results, either automatically or based on user selection. The user can thus seamlessly switch between semantic search and other types of searches in a defined logical flow.

In the embodiment of FIG. 2, semantic search engine 106 filters semantically relevant content to identify and return citations for scoped semantically relevant content. In other embodiments, the filtering of semantically relevant content to a scope can be applied at another component or service. For example, semantic search results 222, in one embodiment, may include citations for snippets from documents not identified in search results 204 or not included in a subset of the documents selected by user 105. UI 104 can apply a filter to limit the results to content from documents having document IDs included in search result 204 (e.g., to the documents having the document IDs stored at parameter update 210).

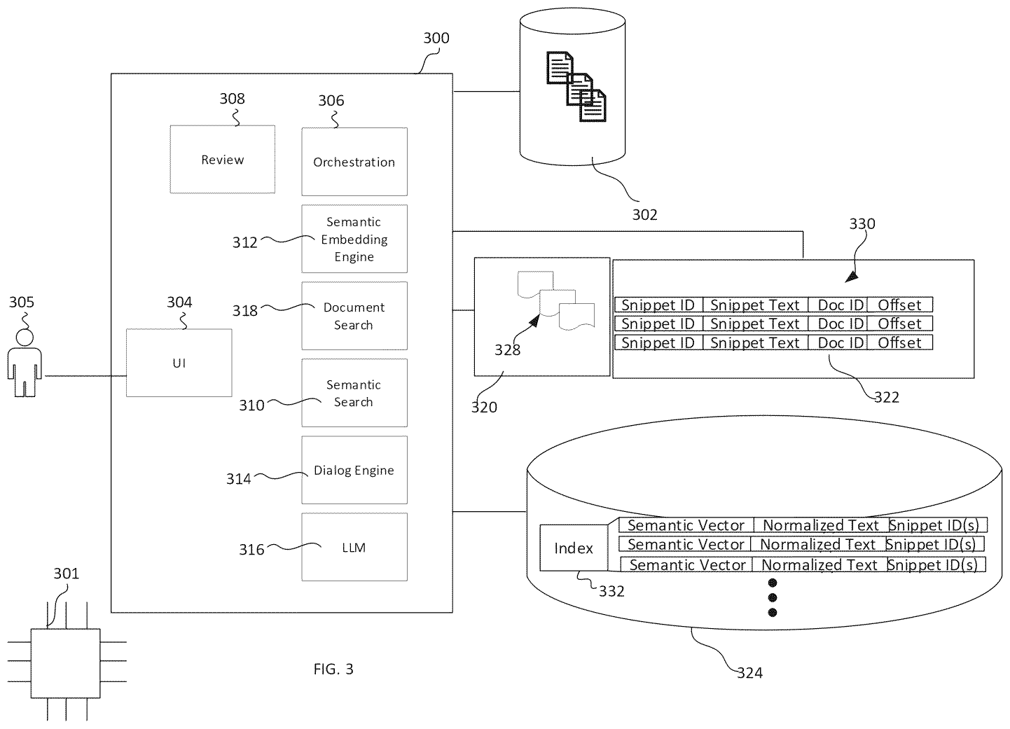

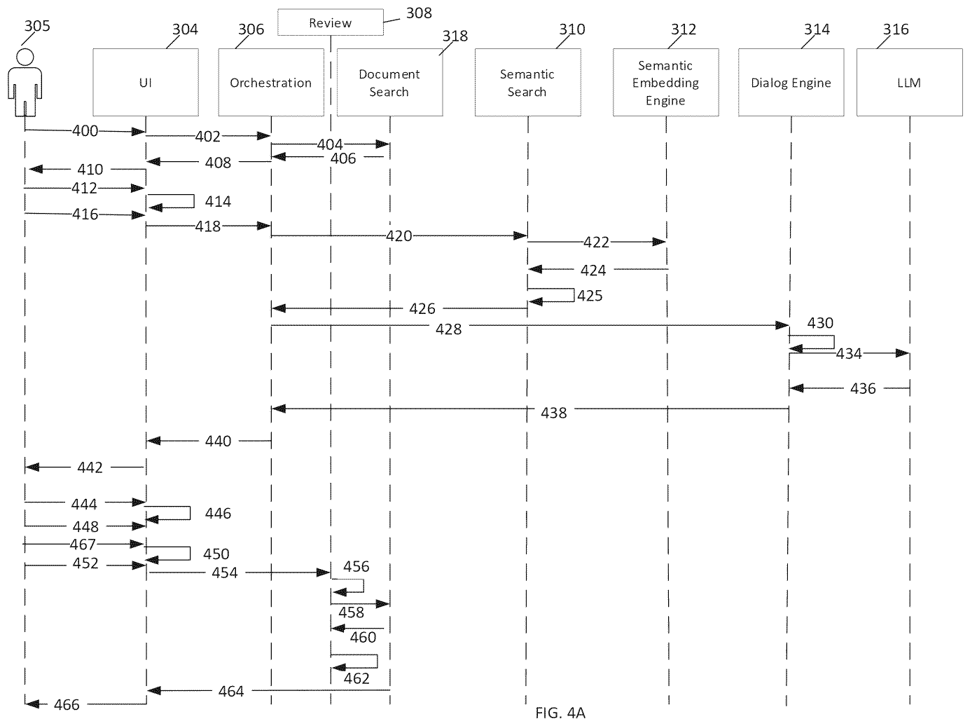

FIG. 3 is a diagrammatic representation of one embodiment of a document analysis system 300. Document analysis system 300 executes on a processor 301, which, in some embodiments, comprises a plurality of processors of a plurality of computers that execute code to provide a document analysis system. The code is embodied, in some embodiments, on a non-transitory, computer readable medium.

Document analysis system 300 supports various types of search technologies for searching a large corpus of documents 302. Document corpus 302 can comprise documents stored on a variety of storage technologies, including across heterogeneous storage technologies (e.g., stored on remote or local databases, remote or local file systems, cloud stores or other storage technologies). As will be appreciated, to support semantic search, documents may be embedded as vectors. Even more particularly, documents may be broken down into more manageable chunks and each chunk embedded as a vector.

In the embodiment illustrated, document analysis system 300 includes a user interface 304 through which a user 305 can interact with the system, a dialog orchestration engine 306, a review service 308, a semantic search engine 310, a semantic embedding engine 312, a dialog engine 314, an LLM 316, and a document search engine 318. According to one embodiment, document search engine 318 is a lexical search engine that searches on metadata fields and, in some systems, document content for literal matches of words, terms, phrases or variants to identify documents and returns the documents that meet the logical constraints specified in the search.

Document analysis system 300 includes a text store 320, a snippet store 322, and an embedding store 324 for storing data related to searching document corpus 302. Each of text store 320, snippet store 322, and embedding store 324 comprises a file system, a database, or other storage technologies or combinations thereof. While illustrated separately, two or more of text store 320, snippet store 322, or embedding store 324 may represent portions of the same data store.

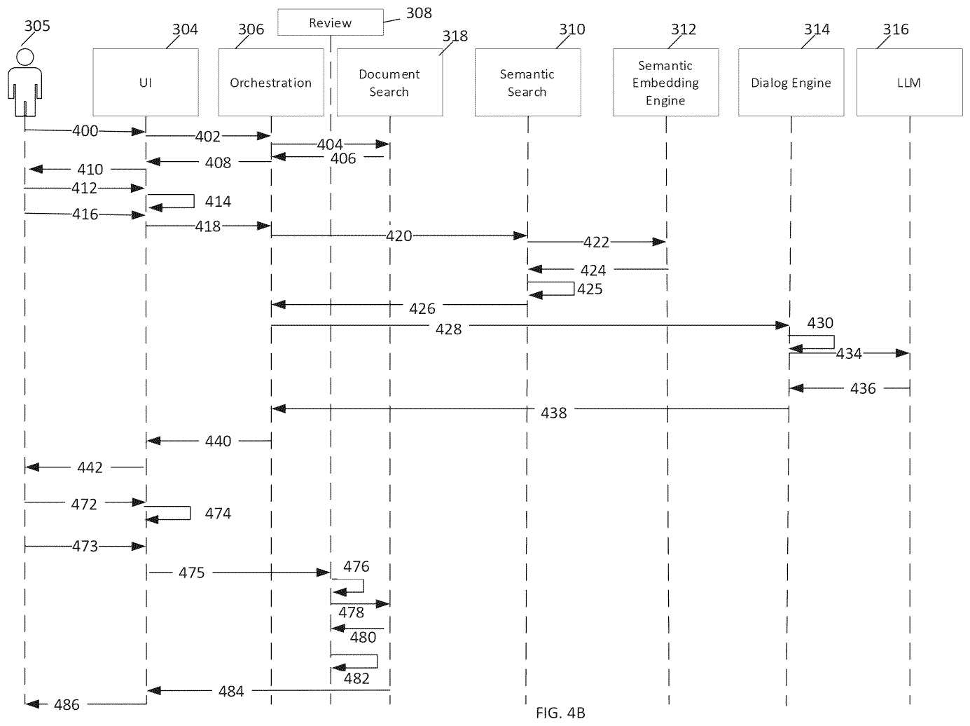

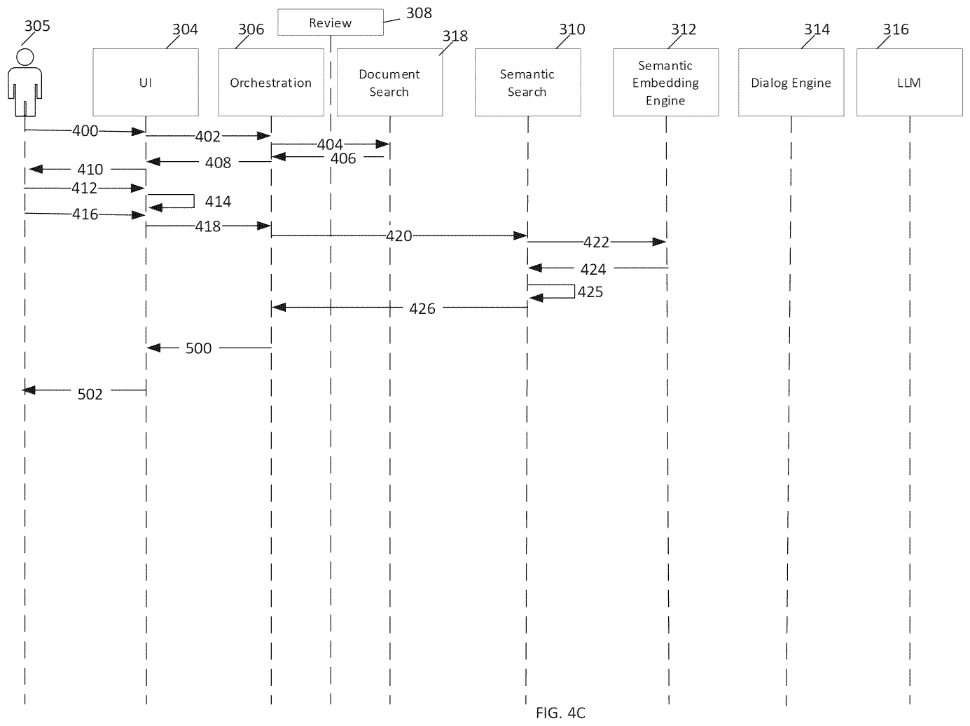

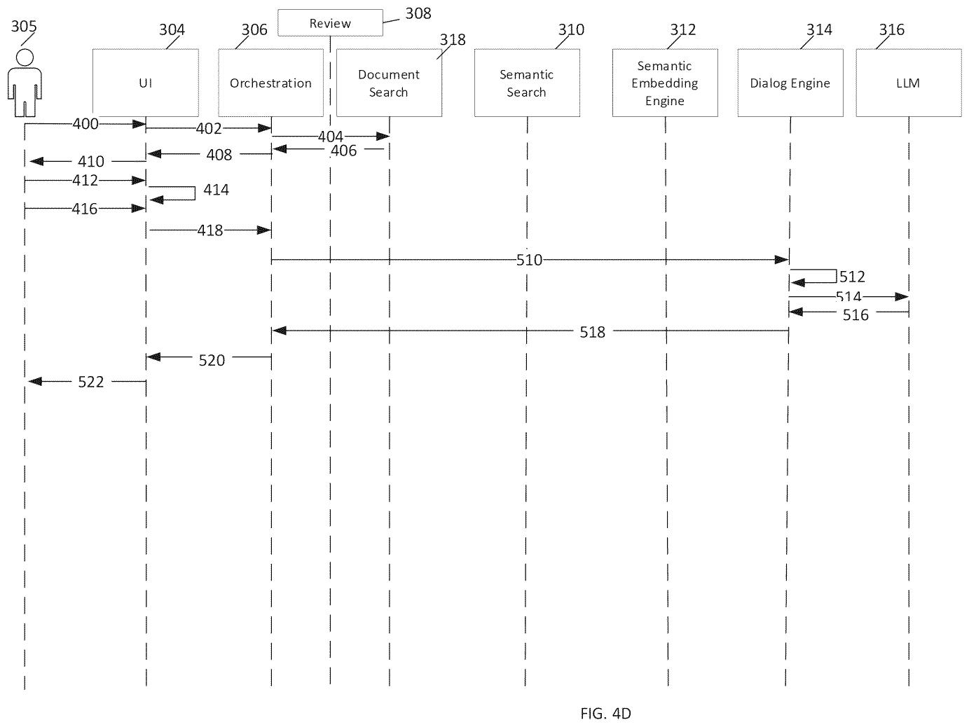

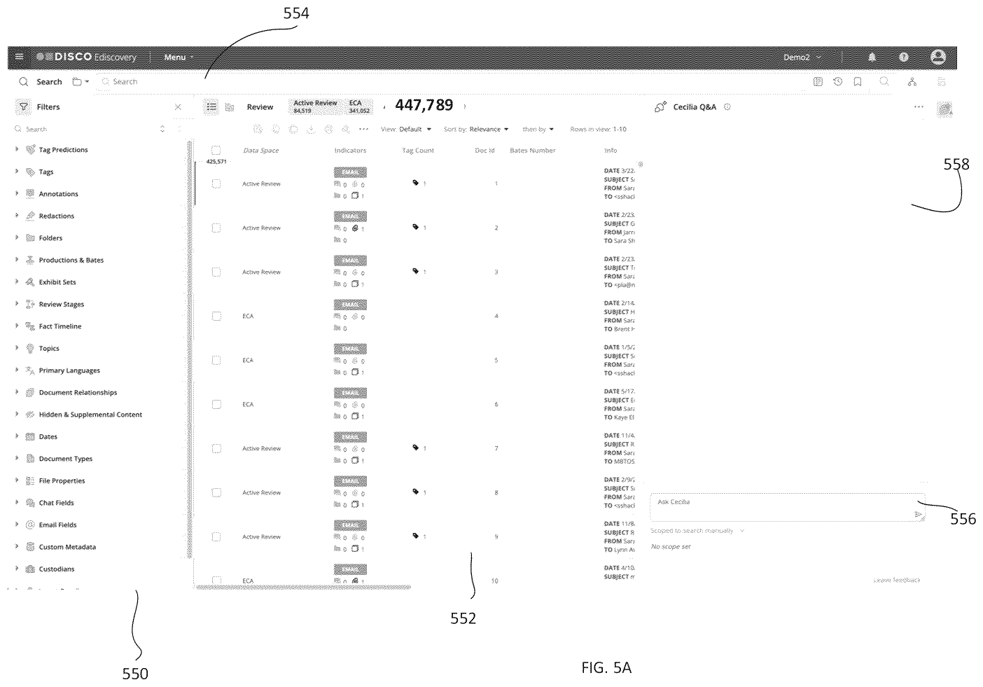

In some embodiments, one or more of semantic search engine 310, semantic embedding engine 312, or LLM 316 are provided by a third party. Further, document analysis system 300 may include additional or alternative services. Thus, for example, a request illustrated as flowing from one component to another in FIG. 4A, FIG. 4B, FIG. 4C or FIG. 4D may be processed and conditioned by one or more intermediate services between the components.

The text of searchable documents from document corpus 302 is stored in document analysis system 300 as index text 328 for the documents. According to one embodiment, the index text 328 for a document comprises a character array of characters from the document—for example, as a single dimensional character array in one embodiment.

To support semantic search, the documents from document corpus 302 may be semantically embedded as document text vectors that represent the document text for semantic searching. More particularly, the documents from document corpus 302 may be broken down into more manageable chunks of text, referred to herein as original text chunks, and the original text chunks semantically embedded as document text vectors. As discussed below, the process of semantically embedding an original text chunk may involve normalizing the original text chunk and semantically embedding the normalized text chunk as the document text vector representing the text chunk.

According to one embodiment, each of the original text chunks associated with a document is a sequence of characters within the index text 328 of a document. In an even more particular embodiment, an original text chunk is a single dimension aware sequence of characters within the index text 328 of a document. According to one embodiment, an original text chunk has a start offset and end offset within the character array of the index text 328 of a document. In some embodiments, the original text chunks follow a set of delineation rules, such as, but not limited to junk text is excluded, punctuation is preserved, capitalization is preserved. The amount of text in an original text chunk will depend on the chunking rules applied. According to one embodiment, the documents from document corpus 302 are chunked into defined grammatical units, such as sentences.

The original text chunks are stored as snippets 330 in snippet store 322. According to one embodiment, a snippet 330 comprises an original text chunk (snippet text), a document ID of a document from document corpus 302, and an offset in a document coordinate system indicating the location of the snippet text in the document (that is, the location of the snippet text in the document having the document ID with which the snippet is associated). A snippet may thus be an original text chunk in the context of a document. Each snippet 330 can be assigned a unique id according to one embodiment.

The snippet texts—that is the original text chunks—from snippets 330 are embedded as document text vectors for semantic search. Various text embedding models known or developed in the art can be used to embed snippets text as semantic vectors for semantic search. According to one embodiment, a multi-qa-mpnet-base-dot-v1 model is used to generate document text vectors. As discussed above, original text chunks may be normalized for embedding as document text vectors.

Embedding store 324 comprises a vector index 332 of snippets that associates the semantically embedded text chunks—that is, the document text vectors—with snippets. In a more particular embodiment, index 332 maps the document text vectors to normalized text chunks from which the document text vectors were generated and the snippets 330 from snippet store 322 that map to the normalized text chunks. Because the snippet text in multiple snippets may map to the same normalized text and hence semantic vector, multiple snippets 330 may map to the same normalized text chunk and document text vector in index 332.

User interface 304 allows user 305 to submit queries for searching and generative AI. Document analysis system 300 can service queries in the context of prior search results. For example, document analysis system 300 may constrain a semantic search to the results of a lexical search or vice versa. Thus, iterative searches may be performed in the context of prior searches.

Document analysis system 300 can apply retrieval augmented generation (RAG), which includes a retrieval stage, an augmentation stage, and a generation stage. In the retrieval stage, document analysis system 300 retrieves text of interest. In the augmentation stage, document analysis system 300 provides the text of interest to LLM 316 as, for example, context for a prompt to help LLM 316 generate a more accurate response to the prompt than LLM 316 would generate in absence of the context. In the generation stage, LLM 316 generates text to respond to the prompt. For example, LLM 316 may answer a question, summarize text, or otherwise generate text to respond to a prompt.

The text of interest for RAG may include, in some embodiments, snippets, normalized text chunks, original text chunks, or documents that are semantically relevant to the query. Accordingly, in the retrieval stage, semantic search engine 310 performs a semantic search of embedding store 324 to identify the text of interest such as semantically relevant snippets, semantically relevant normalized text chunks, semantically relevant original text chunks, or semantically relevant documents. In some embodiments, semantic search engine 310 retrieves and generates a semantic search result that includes the semantically relevant text of interest, which is passed by dialog engine 314 to LLM 316 as, for example, context for responding to the query. In other embodiments, semantic search engine 310 returns a semantic search result that references the semantically relevant snippets, semantically relevant normalized text chunks, semantically relevant original text chunks, or semantically relevant documents, and dialog orchestration engine 306 or dialog engine 314 retrieves the text of interest, which dialog engine 314 provides to LLM 316 as context.

As discussed, a semantic search may occur in the context of a prior non-semantic search. Thus, the semantic search to identify text of interest for RAG may be scoped to results from a prior non-semantic search.

In some embodiments, searches occur in the context of a dialog managed by dialog orchestration engine 306. A dialog is a conversational context that is maintained to allow document analysis system 300 to accumulate state to disambiguate language that is syntactically ambiguous (e.g., what was “her” name) based on well-supported disambiguation elements such as named entities that are correctly implied by the context and not by the syntax. A dialog can comprise one or a sequence of dialog inputs and, in some embodiments, remembers outputs associated with the inputs. Thus, various inputs and outputs in a dialog are associated by a dialog ID. In other embodiments, there is no association between dialog inputs and outputs.

Turning to FIG. 4A, one embodiment of a flow in document analysis system 300 is illustrated. User interface 304 allows user 305 to submit search queries to search corpus 302. In some embodiments, user interface 304 supports different search technologies, including, for example, lexical searching and semantic searching, different semantic search engines or the like. User interface 304 also supports submitting queries to LLM 316, a generative AI-model.

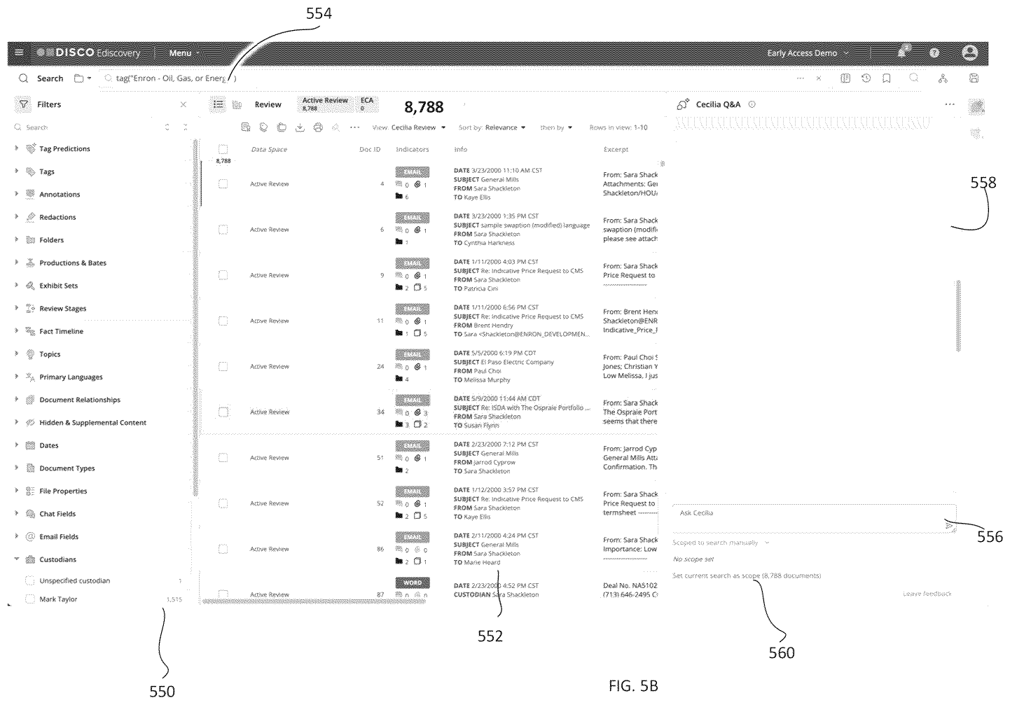

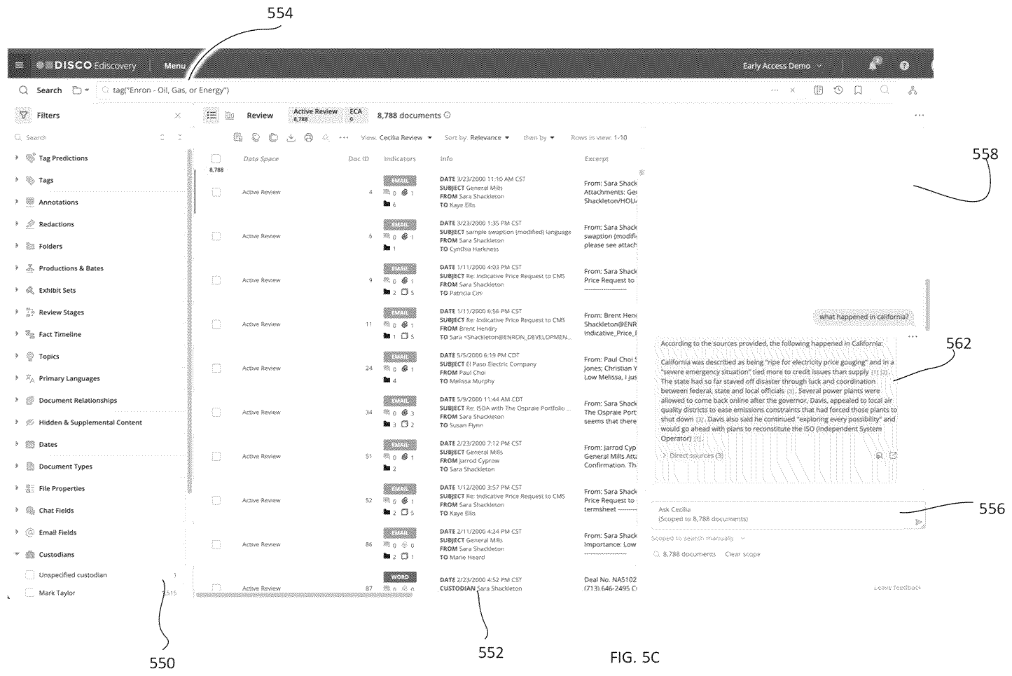

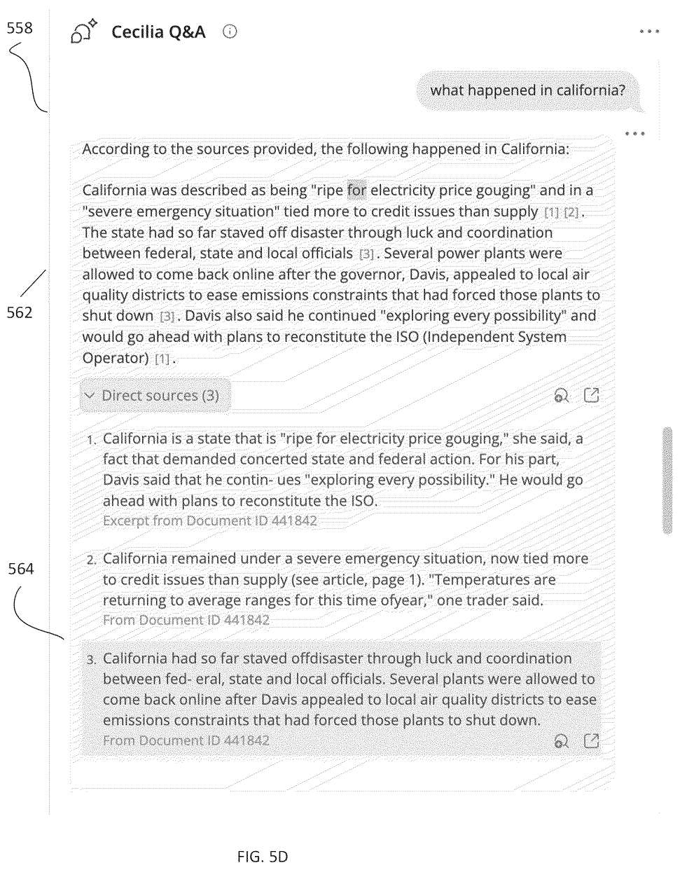

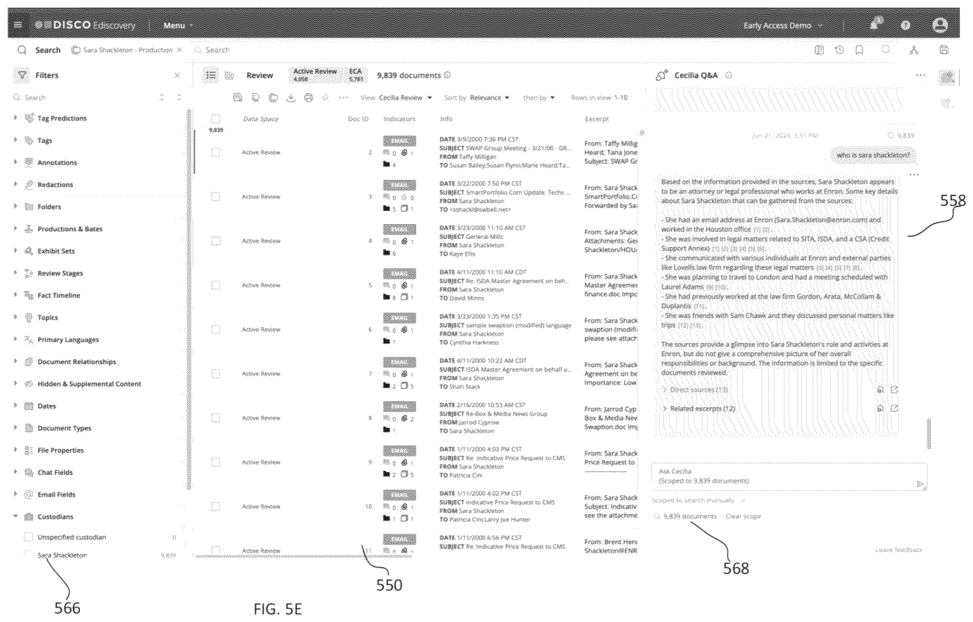

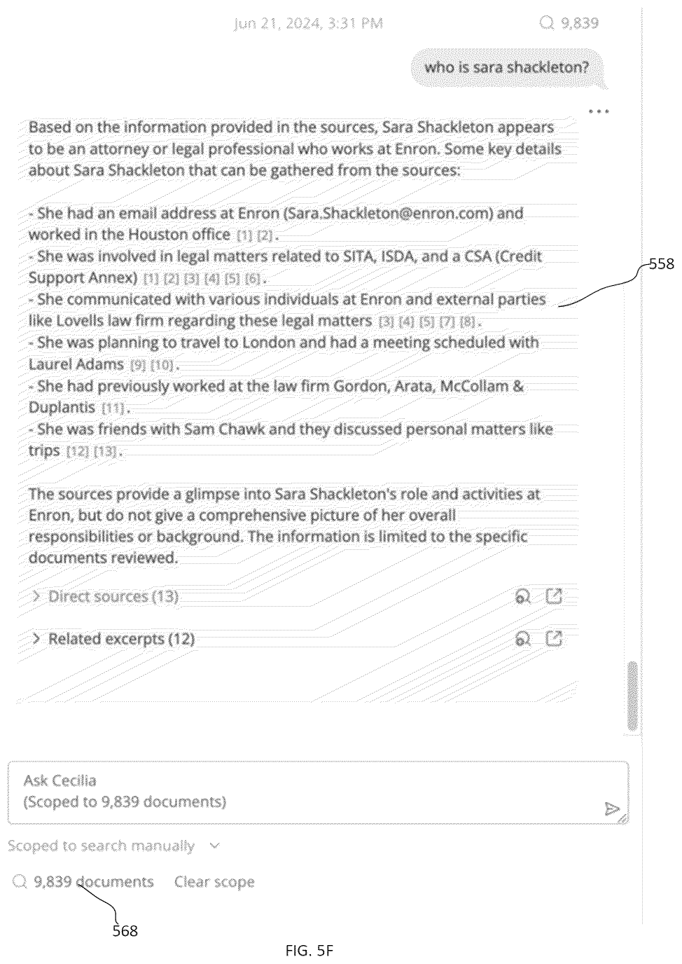

Turning briefly to FIG. 5A, one example embodiment of a UI page 550 provided by one embodiment of UI 304 is illustrated. UI page 550 includes a list of documents 552 in a document corpus (e.g., document corpus 302), a search bar 554 for entering lexical searches, a query bar 556 for querying an AI assistant (e.g., LLM 316), and an AI assistant response area 558. The document corpus includes 447,798 documents.

Returning to FIG. 4A, UI 304 receives a non-semantic search query 400 for document search engine 318. In an embodiment in which document search engine 318 is a lexical search engine, query 400 includes lexical search criteria, such as words, phrases, logical operators, or other search criteria supported by the lexical search engine.

UI 304 sends a dialog request 402 to dialog orchestration engine 306 that includes the user input search criteria. According to one embodiment, dialog orchestration engine 306 begins a dialog. Thus, in some embodiments, subsequent communications between components may include a dialog identifier for the dialog. As discussed, a dialog is a conversational context that is maintained to allow document analysis system 300 to accumulate state to disambiguate language that is syntactically ambiguous.

Dialog orchestration engine 306 sends a search request 404 to document search engine 318 to find documents. Document search engine 318 executes the search and returns search results 406 (e.g., a lexical search result) that includes a list of hits. According to one embodiment, each hit is a reference to a document from corpus 302 that meets the search criteria. For each hit, search results 406 may include, for example, the document ID of the document. In some embodiments, search results 406 include, for each document referenced, one or more of the document name, representative content from the document, or metadata associated with the document.

Dialog orchestration engine 306 returns a response 408 to UI 304 responsive to request 402. Response 408 includes the search results 406 returned by document search engine 318. UI 304 displays the search results to the user (output 410). In one embodiment, UI 304 tracks one or more prior search results in a dialog as potential scopes for servicing subsequent queries.

Turning to FIG. 5B, here the user has selected to perform a lexical search on specific tags available in the system as shown by search bar 554 which is populated with tags (“Enron-Oil, Gas, or Energy”). In this example, document search engine 318 returned 8,788 hits. The user is given the option to scope the context servicing subsequent queries to the results of the lexical search at control 560 (e.g., “Set current search as scope (8,788 documents).”

Returning to FIG. 4A, user 305 may wish to submit a new query (query 416), such as a semantic search query, a question to LLM 316 or another type of query. In one embodiment, UI 304 provides the user the option to scope servicing of a new query to the documents returned from a previous search. For example, the user may select to scope servicing of the next query to the documents referenced returned in the search results 406 included in response 408 (or other prior search results). In some embodiments, user 305 can select a subset of documents from search results 406 to which a subsequent search should be scoped. Based on user interaction with UI 304, UI 304 can thus receive an input 412 indicating that the next query is to be scoped to documents returned in a previous search. UI 304, at parameter update 414, updates query parameters with constraints to limit servicing of the next query to the documents identified in a previous search result (e.g., search results 406 included in response 408). For example, UI 304 updates the query parameters to include the document IDs returned from the prior search (e.g., all the document IDs returned in search results 406 included in response 408 or the document IDs for a selected subset of the documents). For example, if the user selects control 560 of FIG. 5B, document analysis system updates the query parameters for searching to include the document IDs of the 8,788 documents returned in response to the lexical search.

In another embodiment, document analysis system 300 is configured to automatically update the query parameters so that the next search in a defined logical flow, such as a search session, conversation, or a dialog, is to be done in the scope of the previously returned documents without explicit user selection or in the absence of user opt-out. In other words, parameter update 414 may occur automatically without user input.

As discussed, user interface 304, according to some embodiments, supports multiple search technologies. For example, user interface 304 may also allow user 305 to submit a semantic search query or other type of query. Thus, user 305, according to one embodiment, can submit a natural language query 416 that includes an input string, such as “what happened in california?”.

UI 304 sends a request 418 to dialog orchestration engine 306 that includes the user's input string. If servicing of the query is to be scoped to documents returned in a previous search, request 418 can include query parameters to constrain the scope of servicing the request. According to one embodiment, request 418 includes the document IDs of documents determined from a previous search result, such as the document IDs from search results 406 included in response 408 (e.g., as stored at parameter update 414).

Continuing with FIG. 4A, dialog orchestration engine 306 sends a semantic search request 420 to semantic search engine 310 to find citations. Semantic search request 420 includes the user input string (e.g., “what happened in california?”). In one embodiment, semantic search request 420 also includes the document IDs from request 418 (e.g., the document IDs set at parameter update 414).

Semantic search engine 310 sends a request 422 to semantic embedding engine 312 to embed the user input string. Semantic embedding engine 312 semantically embeds the input string (e.g., “what happened in california”) as a semantic vector (a query vector). According to one embodiment, semantic embedding engine 312 embeds the input string in the same way the original text chunks were embedded, including normalizing the input string for embedding in the same manner as the original chunks were normalized for embedding. Semantic embedding engine 312 returns a response 424 to semantic search engine 310 that includes the query vector (that is, the semantically embedded (normalized) input string).

Semantic search engine 310 searches embedding data store 324 using the embedded query string to identify semantically relevant content responsive to semantic search request 420. For example, semantic search engine 310 performs a semantic search of index 332 using the query vector to identify semantically relevant content that is responsive to semantic search request 420 and generates semantic search results 426 based on the responsive semantically relevant content or references to the responsive semantically relevant content. According to one embodiment, semantic search engine 310 supports the approximate matching of text chunks that enables the semantics to be found with related meaning. Non-limiting examples of semantically searching for relevant content are discussed above with respect to semantic search engine 106.

If semantic search request 420 includes search constraints, semantic search engine 310 applies a search scope filter 425 to filter the identified semantically relevant content to only include, as responsive semantically relevant content, the scoped semantically relevant content that is within the search scope specified by the search constraints. In one embodiment, for example, semantic search engine 310 may identify as scoped semantically relevant snippets the semantically relevant snippets that contain a document ID that matches a document ID provided as a constraint in search request 420. Further, semantic search engine 310 may identify as scoped semantically relevant normalized text chunks the semantically relevant normalized text chunks that are mapped to responsive semantically relevant snippets in index 332. Similarly, semantic search engine 310 may identify as scoped semantically relevant documents the semantically relevant documents that have a document ID that matches a document ID provided as a constraint in search request 420.

In another embodiment, semantic search engine 310 is configured to limit the search of documents to documents identified in search request 420. For example, semantic search engine 106 may filter entries in index 332 to only those entries corresponding to documents identified as a constraint in search request 420 and then perform a search to identify semantically relevant content. Thus, the semantically relevant content determined in this manner can be considered scoped semantically relevant content.

According to one embodiment, semantic search results 426 includes citations for responsive semantically relevant snippets. In an even more particular embodiment, semantic search results 426 includes citations for semantically relevant snippets scoped to documents identified in search request 420. According to one embodiment, the citation for a snippet includes snippet information for the snippet where the snippet information for a snippet includes a text chunk (e.g., one or more of the normalized text chunk mapped to the snippet or the original text chunk from the snippet) and a reference to one or more of the snippet (e.g., the snippet ID) or the document identified in the snippet (e.g., the document ID from snippet). Other examples of information that may be included in the snippet information of a citation include but are not limited to the snippet offset, document metadata (e.g., Author or other metadata) of the document identified by the snippet, a citation for a relevance score for the normalized text chunk mapped to the snippet, or relevance score for the original text chunk from the snippet. In some embodiments, the citation for a snippet includes the entire snippet. A citation for a semantically relevant snippet may include, in some embodiments, snippet information for snippets before or after a semantically relevant snippet.

Dialog orchestration engine 306 generates a request 428 to dialog engine 314 to process query 416 using LLM 316. Request 428 includes the search query string (e.g., “what happened in california?”) and additional context information for servicing the query. The additional context information includes or references content of interest to be used as context for servicing query 416. The context information includes, for example, semantically relevant snippets, semantically relevant normalized text chunks, semantically relevant original text chunks, or semantically relevant documents referenced or included in semantic search result 426.

In one embodiment, request 428 includes citations from semantic search results 426 as context information. As discussed above, a citation may include a semantically relevant snippet, semantically relevant original text chunk from a snippet, or a semantically relevant text chunk. Thus, request 428 may include text of interest. In another embodiment, dialog orchestration engine 306 retrieves the documents identified in the semantically relevant snippets included or referenced in semantic search results 426 and provides the documents as context information with request 428.

Based on request 428, dialog engine 314 generates a prompt and context (indicated at 430) for LLM 316 to process the input string entered by the user and inputs the prompt and context (input 434) to LLM 316. According to one embodiment, the prompt includes the input string from the user (e.g., “what happened in california?” from query 416) and the context includes text of interest over which to process the prompt. As nonlimiting examples, dialog engine 314 may be configured to provide citations for semantically relevant snippets, semantically relevant snippets, original text chunks from semantically relevant snippets, semantically relevant normalized text chunks or documents referenced in semantically relevant snippets. If the text of interest is not included with request 428, dialog engine 314 may retrieve the text interest based, for example, on the citations included with request 428.

Dialog engine 314 thus formulates a prompt and context to prompt LLM 316 to answer the question from query 416 using the citations, snippets, original text chunks, normalized text chunks or documents that semantically relevant to that are semantically relevant to query 416 as context. Some example prompts and associated context structures are provided in the attached code appendix.

LLM 316 processes input 434 to generate text and returns a response 436 that includes generative text generated responsive to input 434. For example, LLM 316 answers the question “what happened in california?” using the snippet text from or documents identified in the semantically relevant snippets included or referenced in semantic search result 426 to answer the question “what happened in california?” As will be appreciated, LLM 316 may identify the snippets or documents on which it based its answer.

Dialog engine 314 returns a response 438 to dialog orchestration engine 306 that includes the text generated by LLM 316 and the list of citations, snippets or documents used to generate the answer. Dialog orchestration engine 306 generates a response 440 to UI 304 that includes the semantic search results 426 returned by semantic search engine 310 and the text generated by LLM 316. In one embodiment, response 440 includes the generative text and the citations, snippets, or documents on which LLM 316 based its response.

In the foregoing example of processing query 416 to generate response 440, semantic search engine 310 implemented filtering to filter the semantically relevant content based on a search scope (e.g., document IDs) provided in search request 420. In other embodiments, the filtering of semantically relevant content to a scope can be applied by other components or services. In one embodiment, dialog orchestration engine 306 may apply filters prior to forwarding citations to dialog engine 314 or retrieving text of interest for forwarding to dialog engine 314 to filter the citations from semantic search results 426 to include only those citations that include or reference semantically relevant snippets that contain a document ID that matches a document ID provided as a constraint in request 418 or that reference semantically relevant documents that have a document ID that matches a document ID provided as a constraint in request 418. In another embodiment, dialog engine 314 may apply filters prior to retrieving text of interest for inclusion as context to LLM 316 or generating the context for LLM 316 to scope the text of interest based on document IDs provided in request 428.

User interface 304 displays the results to the user (output 442). FIG. 5C, for example, illustrates one embodiment of interface page 550 updated to display generative text 562 generated by the AI assistant (LLM 316) in response to the question “what happened in california?” using the scope set in FIG. 5B.

The user can continue to ask questions and receive generated text answers. According to one embodiment, the user may interact with user interface 304 to generate inputs that cause interface 304 to update. In one embodiment, user interface 304 receives an input 444 that results in the user interface 304 updating the displayed information (update 446). For example, the user can click on the citation expand button and UI 304 displays the list of snippets returned in the last answer (that is, the snippets returned in response 440 with respect to the last question asked in the dialog). In some embodiments, UI 304 displays the snippets in relevance order.

FIG. 5D illustrates AI assistant response area 558 in which the user has selected to expand the citations to show citations list 564. Here the citations are those referenced in the generative AI text.

Further, in one embodiment, the user can select citations for review. Thus, input 448 may indicate a selection of citations for review. UI 304 updates a set of review query parameters to include the document ids from selected citations (parameter update 450). In some embodiments, parameter update 450 may also include adding the snippet text from the selected citations to the query parameters. User 305 commits the search (input 452). UI 304 generates a request 454 to review service 308 that includes the snippet text and document ids from the selected citation(s). For example, if the user selects the first snippet in citation list 564 of FIG. 5D, UI 304 can formulate a query with the text of the first snippet and the document ID 441842.

In addition to, or in the alternative to, allowing user 305 to select documents to review using citations, UI 304 can provide a search tool to allow the user to search documents using other criteria. Thus, in one embodiment, user 305 may provide an input 467 that indicates a new search query. In such an embodiment, user interface 304 at parameter update 450, updates the query parameters to include the document IDs from the citations selected in input 448, or automatically selected by UI 304, to limit the query to those documents. In some embodiments, UI 304 updates the search input to include the document ids from all the citations returned in the update 446. In some embodiments, UI 304 updates the search input to include the snippet text from the citations. Thus, in one embodiment, when the user commits the search (input 452), UI 304 generates request 454 to review service 308 to include the search criteria from input 467, the document IDs and snippet text from parameter update 450.

Review service 308 parses the request 454 from UI 304 and generates a query (represented at 456 of FIG. 4A). According to one embodiment, review service 308 generates an elastic search query. Review service 308 sends the search query 458 to document search engine 318 and document search engine 318 services the query to generate a response 460. In some embodiments, review service 308 enriches the results (represented at 462) and returns a response 464 to UI 304 that includes search results. UI 304 displays an updated result list to user 305 (output 466).

FIG. 4B illustrates another example flow of document analysis system 300. In this example, document analysis system services query 400 and query 416 as discussed above with respect to FIG. 4A and user interface 304 displays the results (e.g., the response text and citations to the user) (output 442). According to one embodiment, the user is given an option to search within the scope of prior search results, such as search results included in response 440. Based on user interaction with UI 304, UI 304 can thus receive an input 472 indicating that the next search is to be scoped to documents returned from a previous search—for example, the documents identified in the citations included in response 440. In some embodiments, user 305 may select a subset of the documents. UI 304, at parameter update 474, updates query parameters with constraints to limit servicing of the next query to the documents based on the previous search result (e.g., response 440). For example, UI 304 may store the document IDs of the documents identified in the citations or snippets referenced by the citations included in response 440, or selected subset thereof.

In another embodiment, document analysis system 300 is configured to automatically update the query parameters so that the next search in a defined logical flow, such as a search session, conversation, or a dialog, is to be done in the scope of the previously returned documents without explicit user selection or in the absence of user opt-out. In other words, parameter update 474 may occur automatically without user input.

The user enters another search query 473, for example, a lexical search query to review service 308. Query 473 thus includes lexical search criteria, such as words, phrases, logical operators, or other search criteria supported by the lexical search engine. UI 304 formulates a search request 475 to review service 308. The search initiated based on query 473, is scoped to the documents identified in the snippets returned or referenced in search results included in response 440. For example, UI 304 updates the search input to limit the search input to only the documents having document IDs included parameter update 474. In some embodiments, parameter update 474 occurs without user input 472 and the document IDs are added to the search input in the background and transparently to user 305.

Review service 308 parses the request 475 from UI 304 and generates a query (represented at 476 of FIG. 4A). According to one embodiment, review service 308 generates an elastic search query. Review service 308 sends the search query 478 to document search engine 318 and document search engine 318 services the query to generate a response 480. In some embodiments, review service 308 enriches the results (represented at 482) and returns a response 484 to UI 304 that includes search results. UI 304 displays an updated result list 486 to user 305.

In FIG. 4C, semantic search engine 310 services semantic search request 422 as described in conjunction with FIG. 4A. In the embodiment of FIG. 4C, however, dialog orchestration engine 306 returns the semantic search results 426 in response 500 to UI 304 without generative text generated by LLM and UI displays the result list 502 to user 305. The user may then take various actions with respect to the result list, such as selecting citations from search results 426 for further searching (e.g., to cause UI 304 to generate a search request to review service 308 that includes document IDs from selected citations and snippet text from the selected citations), initiating a lexical search that is scoped to document IDs included in the citations from semantic search results 426, or initiating other types of searches.

In FIG. 4D, orchestration engine 306 receives request 418 from UI 304 that includes document IDs (e.g., as set in parameter update 414). Dialog orchestration engine 306 sends a request 510 to dialog engine 314 that includes the input string from query 416 (e.g., “what happened in california?” and context information. In one embodiment, dialog orchestration engine 306 retrieves the documents identified by the document IDs included in request 418 and sends the documents to dialog engine 314 as context information with request 510. In another embodiment, dialog orchestration engine 306 includes the document IDs in the context information but does not retrieve the documents.

Dialog engine 314 receives request 510 and generates a prompt and context (represented at 512). The context includes the documents included or identified in the context information of request 510. If the context information of request 510 does not include the documents, dialog engine 314 retrieves the documents identified by the document IDs in the context information. Thus, dialog engine 314 can generate an input to LLM 316 that includes the prompt and context information. LLM 316 generates text responsive to input 514 to produce generative text 516. Dialog engine 314 returns a response 518 to dialog orchestration service 306 that includes the generative text. Dialog orchestration service 306 generates a response 520 to UI 304 that includes the generative text and UI 304 displays the generative text to user 305 (output 522).

Thus, in the embodiment of FIG. 4D, the results of the non-semantic search initiated by query 400 are used to scope the generative AI.

While embodiments have been discussed above with respect to setting the scope for semantic search or AI-text generation using a non-semantic search, scope for a semantic search or AI-text generation may be set in a number of ways. For example, the user may select a folder that includes documents and use the contents of the folder as the scope. FIG. 5E and FIG. 5F, for example, illustrates an example in which a user has selected a folder 566 that includes 9,839 documents and has set the folder as the scope (indicated at scope 568). Thus, when the user enters the natural language query, “who is sara shackleton” the scope will be the 9,838 documents. That is, the document ids of the 9,839 documents will be included as constraints for the request to semantic search engine 310 in searching for semantically relevant citations to provide LLM 316 to answer the question “who is sara shackleton.” As other examples, filters may be used.

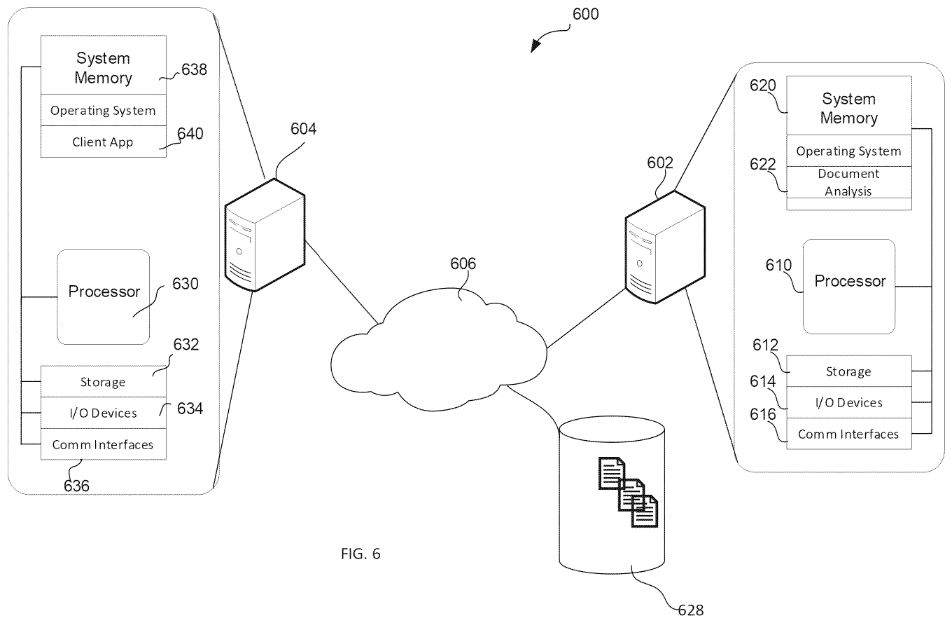

FIG. 6 is a diagrammatic representation of one embodiment of a computing environment 600 that includes a document analysis computer system 602 connected to a client system 604 via network 606.

Document analysis computer system 602 includes a processor 610 and memory 620. Depending on the exact configuration and type of mobile device, memory 620 (storing, among other things, executable instructions) may be volatile (such as RAM), non-volatile (such as ROM, flash memory, etc.), or some combination of the two. Further, Document analysis computer system 602 may also include storage devices 612, such as, but not limited to, solid state storage. Storage devices may provide storage for one or more of a document corpus, document index data, snippets, or a vector index. Similarly, document analysis computer system 602 may also have input device(s) and output device (I/O devices 614) such as keyboard, mouse, pen, voice input, touch screen, speakers. Document analysis computer system 602 further includes communications interfaces 616, such as a cellular interface, a Wi-Fi interface, or other interfaces.

Document analysis computer system 602 includes at least some form of non-transitory computer-readable media. The non-transitory computer-readable readable media can be any available media that can be accessed by processor 610 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, several program modules and data files may be stored in system memory 620. While executing on processor 610, program modules (e.g., applications, Input/Output (I/O) management, and other utilities) may perform processes including, but not limited to, one or more of the stages of the operational methods described with respect to document analysis 100 or document analysis system 300. In one embodiment, system memory 620 stores an operating system and a document analysis application 622. Document analysis application 622 is executable by processor 610 to provide a document analysis system that supports multiple types of searches of a document corpus 628 and can scope searches or LLM queries based on the results of a semantic search.

System memory 620 may include other program modules such as program modules to provide analytics or other services. Furthermore, the program modules may be distributed across computer systems in some embodiments.

Client system 604 includes a processor 630 and memory 638. Depending on the exact configuration and type of computer system, memory 638 (storing, among other things, executable instructions) may be volatile (such as RAM), non-volatile (such as ROM, flash memory, etc.), or some combination of the two. Further, client system 604 may also include storage devices 632. Similarly, client system 604 may also have input device(s) and output device (I/O devices 634) such as keyboard, mouse, pen, voice input, touch screen, speakers. Client system 604 further includes communications interfaces 636, such as a cellular interface, a Wi-Fi interface, or other interfaces.

Client system 604 includes at least some form of non-transitory computer-readable media. The non-transitory computer-readable readable media can be any available media that can be accessed by processor 630 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

Several program modules and data files may be stored in system memory 638. While executing on processor 630, program modules (e.g., applications, Input/Output (I/O) management, and other utilities) may perform processes to enable a user to interact with a document analysis system (e.g., as provided by document analysis application 622). In one embodiment, system memory 638 stores an operating system and a client application 640. Client application, according to one embodiment, is a desktop application for interacting with document analysis application 622. In one embodiment, client application 640 is a web browser. System memory 638 may include other program modules such as program modules to provide analytics or other services. Furthermore, the program modules may be distributed across computer systems in some embodiments.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a CPU, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, HDs, data cartridges, magnetic tapes, floppy diskettes, flash memory drives, optical data storage devices, CD-ROMs, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals, or other information. A processor can include a system with a general-purpose CPU, multiple processing units, dedicated circuitry for achieving functionality, or other systems. Processing need not be limited to a geographic location or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, that follow, a term preceded by “a set”, “a” or “an” (and “the” when antecedent basis is “a” or “an”) includes both singular and plural of such term, unless clearly indicated otherwise (i.e., that the reference “a set”, “a” or “an” clearly indicates only the singular or only the plural). Also, as used in the description herein the meaning of “in” includes “in” and “on” unless the context clearly dictates otherwise.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure.

APPENDIX

--------------------------------------------------------------------------------------------------------------------------
WRITER:
context = ‘\n’.join([f‘- {it.content.strip( )}’ for it in citations_included])
# context is in the form of new-line delimited sentences prefixed with ‘− ’
prompt = (f“Input sentences:<input>\n” +

f“{context}\n” +
“</input>\n” +
“Search the provided input sentences for the relevant information to answer the question.

” +

“Base your response only on the input sentences and substantiate any claim you make. ”

+

“If there is not enough information to answer the question completely and clearly, ” +
“state: ‘Not enough suitable documents for an in-depth answer.’\n\n” +
“Always answer in the past tense. Ensure that you can substantiate any claim you make.

” +

“In crafting your response, aim to provide answers that are not only accurate and based ”

+

“solely on the provided input sentences, but also captivating, and enjoyable to read. ”
“Let your words enthrall the reader while maintaining adherence to the context of the

given materials. ”

“If and only if the answer is not contained in the provided context, say only ‘I couldn't find

a good answer.’ ”

“Your answers should be delightful to read.\n\n”
f“Question: {request.dialog_input}\n” +
“Answer: ”)

---------------------------------------------------------------------------------------------------------------------------
AZURE (GPT)
context = ‘. ’.join([it.content for it in citations_included])
# context is in the form of a paragraph.. with sentences being joined with ‘. ’
prompt = f‘Answer the following question using ONLY the provided context below.\n\n’ + \

f‘Question: {request.dialog_input}\n’ + \
f‘Context: {context}\n\n’ + \
‘Answer the following question using ONLY the provided context. Answer the question

accurately using ONLY the ’ + \

‘provided context. Be descriptive. Try to answer with at least two sentences. Do not

reference specific times or ’ + \

‘date ranges unless requested. If the answer is not contained within the provided context,

say only “I can\'t ’ + \

‘find it in the context”.\n\n’
‘Past-tense Answer: ’

---------------------------------------------------------------------------------------------------------------------------
FLAN
context = ‘. ’.join([it.content for it in citations_included])
# context is in the form of a paragraph.. with sentences being joined with ‘. ’
prompt = f‘Answer based on Context: {context}\n\n’ + \

‘Answer the following question using ONLY the provided context. Answer the question

accurately using ONLY the ’ + \

‘provided context. Be descriptive. Try to answer with at least two sentences. Do not

reference specific times or ’ + \

‘date ranges unless requested. If the answer is not contained within the provided context,

say only “I can\'t ’ + \

‘find it in the context”.\n\n’
f‘Questions: {request.dialog_input}\n’ + \
‘Answer: ’

What is claimed is:

1. A computer-implemented method for searching electronic documents, comprising:
receiving a non-semantic search query from a user to search a document corpus;
executing a non-semantic search according to the non-semantic search query to generate a first search result that identifies first documents from the document corpus;
receiving a natural language query from the user; and
servicing the natural language query to generate a response to the user, servicing the natural language query comprising executing a semantic search scoped to the first documents to generate a semantic search result that identifies semantically relevant content that is semantically relevant to the natural language query.

2. The computer-implemented method of claim 1, wherein the non-semantic search is a lexical search.

3. The computer-implemented method of claim 1, further comprising:
providing the first search result to the user in a graphical user interface; and
receiving, via user interaction with the graphical user interface, an indication to scope the semantic search to the first documents.

4. The computer-implemented method of claim 1, further comprising automatically scoping the semantic search to the first documents.

5. The computer-implemented method of claim 1, wherein the natural language query is a query to an artificial intelligence search assistant.

6. The computer-implemented method of claim 1, wherein servicing the natural language query comprises:
generating an input to a large language model, the input comprising the natural language query and the semantically relevant content to cause the large language model to generate text to respond to the natural language query based on the semantically relevant content;
receiving generative text generated by the large language model in response to the input; and
providing the generative text to the user in response to the natural language query.

7. The computer-implemented method of claim 6, wherein the input to the large language model includes the natural language query as a prompt and the semantically relevant content as a context for responding to the prompt.

8. The computer-implemented method of claim 6, wherein the semantically relevant content comprises semantically relevant text chunks from the first documents.

9. The computer-implemented method of claim 6, wherein the semantically relevant content comprises semantically relevant documents from the first documents.

10. A non-transitory, computer-readable medium storing thereon document analysis code executable by a processor, the document analysis code comprising instructions for:
receiving a non-semantic search query from a user to search a document corpus;
executing a non-semantic search according to the non-semantic search query to generate a first search result that identifies first documents from the document corpus;
receiving a natural language query from the user; and
servicing the natural language query to generate a response to the user, servicing the natural language query comprising executing a semantic search scoped to the first documents to generate a semantic search result that identifies semantically relevant content that is semantically relevant to the natural language query.

11. The non-transitory, computer-readable medium of claim 10, wherein the non-semantic search is a lexical search.

12. The non-transitory, computer-readable medium of claim 10, wherein the document analysis code further comprises instructions for:
providing the first search result to the user in a graphical user interface; and
receiving, via user interaction with the graphical user interface, an indication to scope the semantic search to the first documents.

13. The non-transitory, computer-readable medium of claim 10, wherein the document analysis code further comprises instructions for:
automatically scoping the semantic search to the first documents.

14. The non-transitory, computer-readable medium of claim 10, wherein the natural language query is a query to an artificial intelligence search assistant.

15. The non-transitory, computer-readable medium of claim 10, wherein servicing the natural language query comprises:
generating an input to a large language model, the input comprising the natural language query and the semantically relevant content to cause the large language model to generate text to respond to the natural language query based on the semantically relevant content;
receiving generative text generated by the large language model in response to the input; and
providing the generative text to the user in response to the natural language query.

16. The non-transitory, computer-readable medium of claim 15, wherein the input to the large language model includes the natural language query as a prompt and the semantically relevant content as a context for responding to the prompt.

17. The non-transitory, computer-readable medium of claim 15, wherein the semantically relevant content comprises semantically relevant text chunks from the first documents.

18. The non-transitory, computer-readable medium of claim 15, wherein the semantically relevant content comprises semantically relevant documents from the first documents.

19. A computer system proving enhanced search, the computer system comprising:
storage storing:
a plurality of snippets, each of the plurality of snippets comprising snippet text extracted from a document in a document corpus and a reference to the document from which the snippet text of that snippet was extracted;
an embedding store comprising a vector index of the plurality of snippets;
a processor;
a memory storing:
a non-semantic search engine that is executable to search the document corpus;
a semantic search engine that is executable to perform semantic searching of the document corpus using the vector index; and
instructions executable to scope semantic searches by the semantic search engine to documents identified in search results from the non-semantic search engine.

20. The computer system of claim 19, wherein the non-semantic search engine is a lexical search engine.

21. The computer system of claim 19, wherein the memory further stores instructions executable to:
receive a non-semantic search result from the non-semantic search engine the non-semantic search results comprising document identifiers for first documents from the document corpus;
store the document identifiers from the non-semantic search results as query parameters for a subsequent search;
subsequent to receiving the non-semantic search result, receive a natural language query that includes a query string from a user; and
generate a request to the semantic search engine that includes the query string and the document identifiers that were stored as query parameters, wherein the semantic search engine is executable to:
receive the query string and the document identifiers; and
execute a corresponding semantic search scoped to the first documents to generate a semantic search result that identifies semantically relevant content that is semantically relevant to the query string.

22. The computer system of claim 21, wherein the memory further stores instructions executable to:
generate an input to a large language model, the input to the large language model comprising the query string and the semantically relevant content from the semantic search result;
receive generative text generated by the large language model to respond to the input string based on the semantically relevant content; and
display the generative text to the user.
